(19) United States
(12) Patent Application Publication
(10) Pub. No.: US 2015/0379210 A1
(43) Pub. Date: Dec. 31, 2015

(54) SELECTING A SET OF DOCUMENTS FROM A HEALTH RECORD OF A PATIENT

(71) Applicant: KONINKLIJKE PHILIPS N.V., EINDHOVEN (NL)

(72) Inventors: Iwo Willem Oscar Serlie, Noord Brabant (NL); Thusitha Dananjaya De Silva MABOTUWANA, Yonkers, NY (US); Johannes BUURMAN, 's-Hertogenbosch (NL); Yuechen Qian, Briarcliff Manor, NY (US); Merlijn Sevenster, Chicago, IL (US); Zarko Aleksovski, Eindhoven (NL); Rudolph Martherus, Vlissingen (NL)

(21) Appl. No.: 14/767,970

(22) PCT Filed: Mar. 12, 2014
(86) PCT No.: PCT/IB2014/059653

§ 371 Date: Aug. 14, 2015

Related U.S. Application Data
(60) Provisional application No. 61/803,493, filed on Mar. 20, 2013.

(51) Int. Cl. G06F 19/00

(52) U.S. Cl. CPC G06F 19/322; G06F 19/3443

(57) ABSTRACT

A system for selecting a set of documents from a health record of a patient (1) is disclosed. A specialty unit (21) is arranged for determining a specialty (3) for selecting the set of documents, to obtain a determined specialty. A first selecting unit (4) is arranged for selecting a first set of documents (5) from the health record, wherein a specialty of a physician associated with the documents of the first set of documents (5) matches the determined specialty. A body part determining unit (6) is arranged for determining a body part (7) associated with at least one document of the first set of documents (5), to obtain a body part. A second selecting unit (8) is arranged for selecting a second set of documents (9) from the health record, wherein a body part associated with the documents of the second set of documents matches the determined body part.

### FIELD OF THE INVENTION

The invention relates to selecting a set of documents from the health record of a patient.

### BACKGROUND OF THE INVENTION

It is known that, in the hospital environment, imaging data is captured by medical imaging systems. The images are created using many existing methods, including radiography, or X-ray imaging, computed tomography (CT), magnetic resonance imaging (MRI), ultrasound, mammography, nuclear medicine, positron emission tomography (PET), and other modalities. These images are part of the electronic patient record. The amount of available imaging data per patient record available to physicians can be very high. Also, other kinds of documents such as laboratory results, reports, etc. are part of the health record of a patient. Finding the relevant documents in the health record of a patient could be extremely time consuming for a physician.

“Integrated Visualization of Problemcentric Urologic Patient Records”, by A. A. T. Bui et al., Ann. N.Y. Acad. Sci. 980: 267-277, 2002, discloses a system for the classification and filtering of medical data based on the user, specialty, medical problem, the reason for examining patient data, or body part. The method includes selecting the type of filtering and visualizing the filtered information.

### SUMMARY OF THE INVENTION

It would be advantageous to have an improved method of selecting a set of documents from the health record of a patient. To better address this concern, a first aspect of the invention provides a system comprising

a specialty unit for determining a specialty to be used for selecting the set of documents, to obtain a determined specialty;

a first selecting unit for selecting a first set of documents from the health record, wherein a specialty of a physician associated with the documents of the first set of documents matches the determined specialty;

a body part determining unit for determining a body part associated with at least one document of the first set of documents, to obtain a determined body part;

and a second selecting unit for selecting a second set of documents from the health record, wherein a body part associated with the documents of the second set of documents matches the determined body part.

This provides a more efficient document selecting system, as the system may allow for selecting a set of documents from the health record of the patient, avoiding the necessity of going through all the documents for finding the most relevant ones. Alternatively, the system may provide a more reliable selection of documents, as this selection is based on specialty and body part, therefore allowing the selection of documents with more clinically relevant content and reducing the risk of overlooking important documents. For example, at least some of the documents may be imaging studies. Such imaging studies may comprise one or more medical image datasets. The specialty unit may be arranged for determining the specialty of a referring physician, wherein the referring physician is the physician who ordered a study.

The system may further comprise a display setting determining unit for determining a document display setting associated with at least one document of the first set of documents, wherein the document display setting relates to information regarding a display setting used in a previous display of the document, to obtain a determined document display setting;

and wherein the second selecting unit is further arranged for matching a display setting associated with a document from the health record with the determined document display setting. This allows to find a more relevant set of documents, as the filtering also takes into account the display settings that were assigned by default or used in the past for the documents from the health record. For example, such display settings may be correlated with the body part that was inspected.

The specialty unit may further be arranged for selecting a query document from the health record of the patient and for determining a specialty of a physician associated with the selected document as the determined specialty. In this way, the first and second sets of documents are relevant when reporting on the query document. For example, a physician may provide input to select a document from the health record, or the document selection could be done in an automatic way.

If the specialty unit fails in determining the determined specialty, the second selecting unit may be arranged for determining the second set of documents by extracting from the health record of the patient a set of documents wherein a body part associated with the documents of the second set of documents matches the body part associated with the query document. This allows to select relevant documents even in the case wherein a specialty may not be determined.

The specialty unit may be further arranged for extracting an identifier of the physician from metadata of the query document and determining the determined specialty of the physician associated with the document based on a table of identifiers of physicians and associated specialties. This is an appropriate way of obtaining the specialty of the physician, even if this information is not explicitly stored with the document.

The system may further comprise:

a study analysis unit for analyzing a document of the health record to extract date information from the document, the date information being indicative of date of a study related to the document;

and a third selecting unit for selecting a further document from the health record based on a date of the further document matching the date of the study.

This aspect of the present invention is based on the recognition that certain patients, such as those with chronic conditions, may be subjected to a large number of studies over time, resulting in the patient's health record comprising a large number of documents. However, the documents in a particular health record may be concerned with different diseases or different aspects of a disease. Accordingly, it may be difficult to follow the progression of the patient's condition with respect to a specific disease of specific aspect of a disease. The above measures enable a further document to be selected which concerns a study related to an initial (query) document, or in general a set of documents to be selected which are mutually related, i.e., concern the same disease or the same aspect of the disease.

The study analysis unit may be arranged for extracting the date information from the document by detecting the date of a prior study in a comparison section of the document, and/or detecting a follow-up recommendation indicative of the date of a follow-up study. The comparison section of a document typically identifies a prior study, also referred to as baseline study, by date. Moreover, a follow-up recommendation is typically indicative of the date of a follow-up study in that it indicates a time period or time range with respect to the current date. Accordingly, relevant date information can be extracted from the document.

The study analysis unit and the third selecting unit may be arranged for iteratively selecting and analyzing further documents from the health record to obtain a third set of documents corresponding to a sequence of studies. By iteratively analyzing a document, selecting a further document based on a result of the analysis, analyzing the further document, etc, a series of documents may be selected which correspond to a sequence of related studies. Accordingly, a document selecting system is established which may efficiently select all documents concerning a same disease or a same aspect of a disease.

The first selecting unit may be arranged for selecting the first set of documents from the third set of documents, and/or the second selecting unit may be arranged for selecting the second set of documents from the third set of documents. Accordingly, a sub-selection is made from the third set of documents based on matching specialty and/or body part. Such matching specialty and/or body part may constitute a class of documents. Accordingly, documents belonging to a same class may be selected from the third set of documents. For example, in a sequence of studies, documents may be selected which concern studies of the brain, whereas studies of the chest or abdomen may be omitted.

The third selecting unit may be arranged for selecting the third set of documents from the first set of documents and/or the second set of documents. This constitutes an another way of efficiently selecting related documents from the health record.

The body part determining unit may be further arranged for determining the body part based on metadata of said at least one document of the first set of documents. This allows for an automatic and consistent selection of documents.

The body part determining unit may be arranged for determining the determined body part using at least one of a Study Description field, a Protocol Name field, and a Series Description field of the metadata of said at least one document of the first set of documents. This way, a more reliable selection of documents may be realized, as more relevant information may be used for determining the body part, increasing the confidence in determining the body part correctly.

The determined body part may comprise a vector representing a plurality of body parts associated with said at least one document of the first set of documents. This allows a more sophisticated determining and/or matching of the body part. For example, while the body part associated to a document may be the arm, also the hand and the elbow could be represented in this vector, if they are all associated with the document.

The body part determining unit may be further arranged for using a taxonomy to determine the determined body part and the second selecting unit may be arranged for using the taxonomy to select the second set of documents from the health record. In this way a more reliable body part may be determined. The taxonomy may be used, for example, to match taxonomically related body parts and/or to match different representations of the same body part. The taxonomy may be used by the body part determining unit and/or the second selecting unit, for example to process the content of the Study Description field, the Protocol Name field, or the Series Description field associated with a document, to determine and/or match body parts related to terms used in those fields according to the taxonomy.

The system may further comprise a time range generating unit to generate a time range based on the determined specialty. The first or the second selecting unit may be arranged for selecting the first or the second set of documents, respectively, from the health record of the patient. A creation time of the documents of the first or second set of documents, respectively, may be inside the time range. This allows for improving the relevancy of the documents in the first or second set of images, respectively, as the relevant time range for documents may depend on the specialty of the physician.

The system may further comprise a display unit for displaying the first set of documents and the second set of documents and displaying, for each document, an indication of the set to which each document belongs. In this way, the time necessary for a user checking the documents included in the set may be reduced.

The system may further comprise a pre-fetch unit for pre-fetching at least one of: the first set of documents, the second set of documents, and the third set of documents, from a database comprising the health record.

In another aspect, the invention provides a method for selecting a set of documents from a health record of a patient, wherein the health record comprises a plurality of documents, the method comprising the steps of:

determining a specialty to be used for selecting the set of documents, to obtain a determined specialty;

selecting a first set of documents from the health record, wherein a specialty of a physician associated with the documents of the first set of documents matches the determined specialty;

determining a body part associated with at least one document of the first set of documents, to obtain a determined body part;

and selecting a second set of documents from the health record, wherein a body part associated with the documents of the second set of documents matches the determined body part.

In another aspect, the invention provides a computer program product comprising instructions for causing a computer system to perform the method set forth.

It will be appreciated by those skilled in the art that two or more of the above-mentioned embodiments, implementations, and/or aspects of the invention may be combined in any way deemed useful.

Modifications and variations of the workstation, the method, and/or the computer program product, which correspond to the described modifications and variations of the system, can be carried out by a person skilled in the art on the basis of the present description.

It will be evident to the reader that, although the emphasis of the description of the invention is on the healthcare field, embodiments of the invention may be used in other fields where selection of documents are executed.

### BRIEF DESCRIPTION OF THE DRAWINGS

These and other aspects of the invention are apparent from and will be elucidated hereinafter with reference to the drawings.

FIG. 1 is a diagram illustrating aspects of a system for selecting a set of documents from the health record of a patient.

FIG. 2 is a flowchart of a method of selecting a set of documents from the health record of a patient.

FIG. 3 shows elements of a graphical user interface.

### DETAILED DESCRIPTION OF EMBODIMENTS

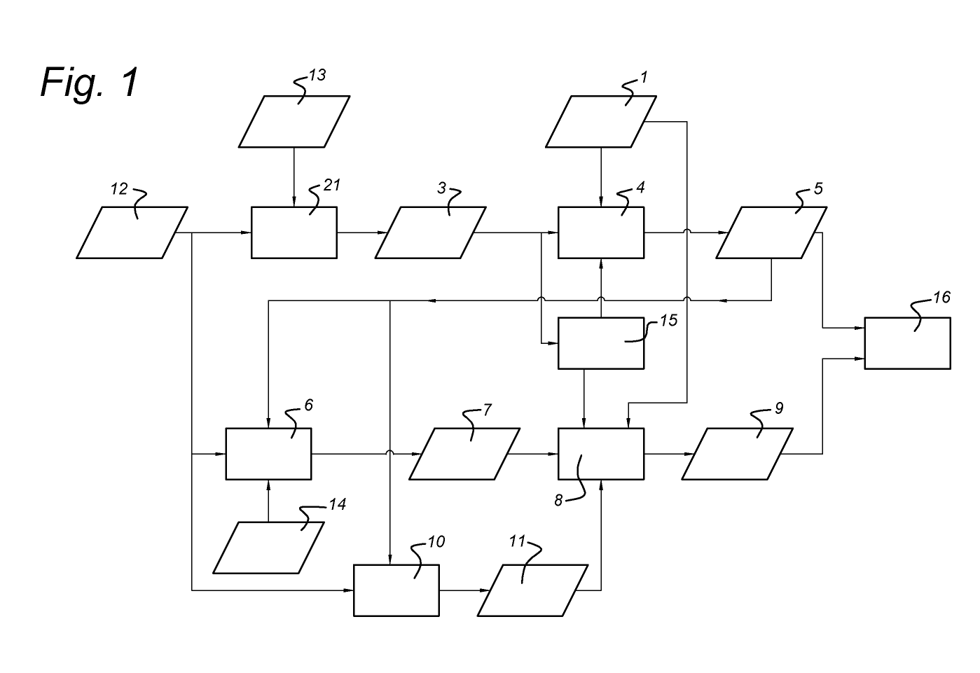

FIG. 1 is a diagram illustrating aspects of a system for selecting a set of documents from the health record of a patient. The system may be implemented at least partly as a software application to run on a computer system. Such a computer system may be a distributed computer system or a standalone workstation, for example. The system for selecting a set of documents from the health record of a patient may be implemented, for example, on the server of a client-server system, and the user interface may be implemented in the client of the client-server system. Although the system is described herein in detail, it will be understood that for many features described herein, alternative solutions may be used without departing from the scope of the claims.

In general terms, the system is arranged to select a first set of imaging studies from the health record of a patient, based on the specialty of the physician of those imaging studies. After this, the system generates a second set of imaging studies from the health record of the patient based on the body part associated with one or more of the imaging studies of the first set.

The system may comprise a specialty unit 21 configured to determine a specialty 3. Whenever requested, this module may determine a determined specialty. The specialty may be determined in multiple ways or obtained from different sources depending on the circumstances. For example, the specialty may be extracted directly from data that could be found in a query document, or it may be the specialty of a physician that is using the system, based on a log-in identifier of a user of the system, for example. The specialty may further be determined from a table comprising identifiers and specialties, an identifier may be extracted first and the specialty matching that identifier in the table may be the determined specialty. The specialty unit 21 may be arranged for extracting a variety of DICOM header values from one or more documents, which are used to describe the document itself.

The system may further comprise a first selecting unit 4 configured to receive a determined specialty 3 in order to select a first set of documents 5 from the health record of the patient wherein the specialty associated with at least one of the documents of this first set of documents 5 matches the determined specialty 3.

The system may comprise a body part determining unit 6 configured to determine a body part 7. Whenever requested, this module may determine a determined body part. The body part 7 may be determined in multiple ways or obtained from different sources depending on the circumstances. For example, the body part may be extracted directly from data that could be found in a document. The body part may further be determined by matching the data from the document against a taxonomy 14. The body part determining unit 6 may be arranged for extracting a variety of DICOM header values, or other kinds of metadata, from one or more documents, which are used to describe the document itself, for example study description, protocol name, or series description.

The system may further comprise a second selecting unit 8 configured to receive a determined body part 7 in order to select a second set of documents 9 from the first set of documents 5 wherein the body part associated with at least one of the documents of this second set of documents 9 matches the determined body part.

The second selecting unit 8 may be further arranged for extracting the body part 7 from the query document 12 if a first set of documents could not be generated, for instance due to a fail of the specialty unit 21 in determining the specialty 3.

The system may further comprise a time generating unit 15 arranged to generate a time range. The first and second selecting units may be arranged for selecting documents from the health record wherein the time of creation of those documents is within the time range. This time range may be generated based on the determined specialty 3, for instance for a pediatric specialty all events in a child's life could be of interest, while a cardiologist is typically more concerned with information on short term.

The system may further comprise a display unit 16. The first and second set of documents may be displayed using this display unit 16. The display unit 16 may be configured to display the documents by means of a symbol or an icon or a text label, for example. The documents may be arranged on a timeline, for example. For each document, an indication of the set to which it belongs (the first set of documents or the second set of documents) may be displayed, for example by means of the positioning of the document or by means of a different color or another kind of indication. The display unit may be operatively connected to a display device such as a computer monitor. A user interface may be connected to the display unit 16. The user interface may be further arranged for allowing the selection of at least one of the documents displayed as a query document 12. This query document may provided to the specialty unit to trigger updating of the first and/or second set of documents.

The system may further comprise a display setting determining unit 10 configured to determine a display setting 11. The display setting 11 may be determined in multiple ways or obtained from different sources depending on the circumstances. For example, the display settings may be extracted directly from data that could be found in a document. The display settings may comprise window width or window level or any other displaying setting of interest.

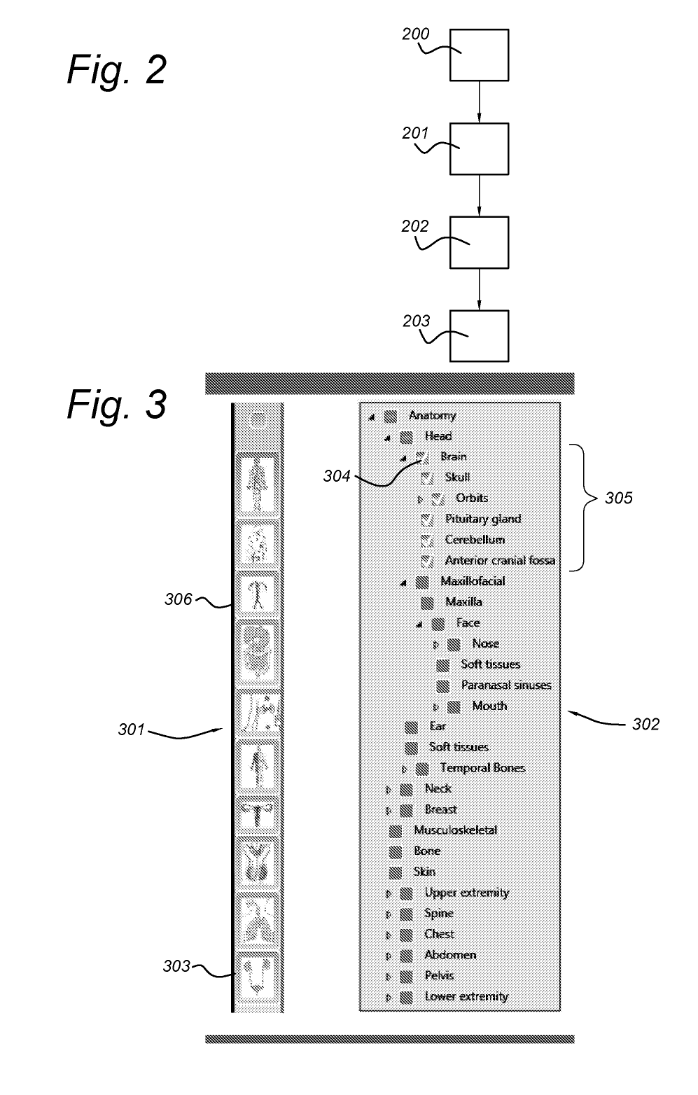

FIG. 2 illustrates a method of selecting a set of documents from the health record of a patient. The method may be implemented as a computer program product. Such a computer program product may be operative on a medical device or server system, for example. When implemented on a server system, an interface to at least one workstation or any other kind of user terminal may be provided to enable the user to provide inputs and/or review results. The method may also be implemented using dedicated electronic circuitry.

The method may comprise a step 200 of determining a specialty. The specialty may be received, for example, from a user interface. The specialty may as well be determined from a query document. Metadata associated with the document may be used to determine the specialty. This metadata may be DICOM headers. Several fields from the metadata may be used, for instance, the Study Description field, the Protocol Name field, or the series Description field. However, other fields may be used for determining the specialty, and the specialty may be determined in other ways. For example, the specialty is the specialty of a referring physician of the images to be selected.

The method may further comprise a step 201 of selecting a first set of documents from the health record, wherein the specialty associated with the selected documents matches the specialty determined in step 200.

At step 202, the method determines a body part associated with at least one document of the first set of documents. The body part may comprise a vector or may be further determined using a taxonomy.

The method may proceed to step 203 of selecting a second set of documents wherein the body part associated with these documents matches the body part determined in step 202.

Step 200, 201, 202, and 203 may be repeated any number of times, whenever a set of documents need to be selected.

The techniques described herein may be applied in the field of Clinical Decision Support (CDS). For example, a CDS that assists clinicians in the access and use of relevant priors as reference material. Relevant priors are used as reference material with a current study. For example, the visualization of progression or regression involves a comparison with prior reference material. For example, from the DICOM header, the imaging modality and body part may be extracted. These may be used to define relevancy of priors.

If the combination of body part and imaging modality alone is considered unreliable in selecting a relevant subset of patient's history, this may lead to a time-consuming full inspection of patients' history to avoid incompleteness of relevant prior data.

The selection of relevant prior data may be improved by basing the selection also on clinical criteria and not on technical criteria only. Body Part is a technician's code for the area that should be scanned (e.g. the liver) and does not refer necessarily to the specific body part that is under investigation. It is not uniquely related to a pathological condition of an organ. Moreover, pathology is not uniquely related to an imaging modality (e.g. multiple imaging modalities allow the detection of one pathological condition of for example lung fluid; one imaging modality such as the chest X-ray can reveal many pathological conditions of for example the heart and lungs).

A method may be performed to obtain a subset of the patient's history as prior reference materials, in which the episodes of care primarily drive the relevancy filtering. At stage one, studies in the patient's history may be included based on the specialty of the patient's physician or referring physician. At stage two, studies may be included requested by other physician specialties that share the body part of studies identified at stage one.

Relevant priors may be studies grouped per the episodes of care, which are related to the specialty of the patient's physician or referring physician. Relevant priors may be studies that are related to identical organs, pathology and current study. The specialty of the physician is related to the combination of organs and their pathological condition. The definition of “episode of care” is a cluster of service by a health care facility or provider for a specific medical problem or condition.

In addition to the aforementioned relevancy filtering, it is possible to extract all episodes of care from the patient's history automatically and display them to expand the subsets of patient's history regarding the episodes of care. The visualization of the subset from patient's history can be such that it reveals if data were obtained from the first filter stage or from the second filter stage.

The method comprises filtering of the patient's history with a specific time range. However, an episode of care might be selected in full if part of it is selected.

A physician might have multiple specialties. This may be taken into account in the first selecting unit 4, for example, by selecting the documents that match any of the specialties of the referring physician of a query image. However, multiple specialties may also be dealt with in another way.

The filter function may be configured to behave differently per type or user or specialty. For example, the time range might be configured differently per specialty (e.g. pediatric specialty typically wants to see all events in a child's life while a cardiologist is more concerned with information on short term).

The display unit 16 may generate a timeline in which the position of highlighted priors reveal if relevancy is primarily based on identical specialty or based on a match between body part and body part of initial prior (or query document).

The mechanisms described herein may result in prior data selection that better fits the needs and expectations of the user. The first and second sets of documents may comprise clinically related content, minimizing the need to check the complete patient's history for overlooked relevant priors allowing the user to be more time efficient. Data may be grouped with regard to the episodes of care.

In a specific example, the method can be implemented by using the following steps:

Create a list that maps the referring physician to a specific specialty. The referring physician information is available in the DICOM header of each imaging study, and user information along with the user's specialty is stored in the PACS. This information is used to create the mapping between the referring physician and a specific specialty.

Obtain the referring physician from all studies for the patient from the PACS.

Filter exams that have identical specialty.

Obtain body structures in filtered studies from the associated DICOM header.

Obtain studies from the patient's history that address similar body structures as obtained in the previous step.

The radiology reporting workflow may involve the radiologist first looking at one or more relevant prior reports (and the imaging data if needed) before creating the report for the current exam. Which prior imaging studies are relevant can be automatically determined by the PACS system based on a study's anatomy as indicated in the Body Part Examined field of the DICOM header, or a similar field in another metadata format. This body part field is fairy abstract; for instance, a study done to exclude pancreatitis and another study done to exclude renal stones may both have their body part field set to abdomen. As a result, there is room to improve the relevant prior study matching techniques as well as support better prior study filtering. An approach to determine the body part that is the subject of an imaging study using the DICOM Study Description and/or Protocol Description and/or Series Description fields may provide better results. Such an approach may support relevant prior study matching and filtering at a more granular level.

On a routine basis, radiologists work with an increasing number of images to diagnose and treat patients in an optimal manner. Patients, especially ones with cancers, frequently undergo imaging exams and, over time, accumulate many studies in their medical records often pertaining to the same anatomical region. Each time a new study needs to be read, the radiologist would typically open the current imaging order to understand the clinical context and why the study has been performed. The radiologist would then determine the most relevant prior study (e.g., based on modality and/or anatomy) to understand the status of the patient's findings and establish a reference point to compare current findings against.

After an imaging study is performed at a modality workstation such as X-Ray, CT or MM, images are transferred to the PACS, for example using DICOM standard. During this transfer process, each image's DICOM header gets populated with various study related attributes such as study date-time, modality, scanner manufacturer, study description, protocol description, scanned body part and the like.

Workload of radiologists has increased significantly in recent years and to keep up with demanding workload, radiologists typically review only the one or two most recent relevant prior studies. A PACS system can show the relevant prior studies according to specific matching rules set by the PACS vendor and/or radiologist preference (referred to as the hanging protocol). For instance, if a study, for example a head study, is opened in iSite Radiology, the Patient History Timeline shows all studies for the patient while the Relevant Exams shows the prior exams related to the current study, matched by body part of the opened study (for example head).

Radiologists often need to look at relevant prior studies for comparison purposes. Relevant prior study matching can be done based on the study's anatomy (and sometimes modality as well) as indicated in the Body Part Examined field corresponding to DICOM tag (0018, 0015). However, there are two limitations of using the body part field alone:

The body part field of the DICOM header is fairly high level and may not always provide the level of granularity needed. For instance, a study done to exclude pancreatitis and another study done to exclude renal stones may both have their body part field set to abdomen. In this example, if pancreas and kidney could be determined as the corresponding body part respectively, the prior study matching and filtering may be performed at a more granular level.
The body part field is typically populated based on the procedure used at a given institute. A given procedure name may not always belong to an obvious body part. For instance, a CT Angiogram (CTA) of the neck may be used to determine blockage or narrowing of the arteries in the neck that carry blood to the brain, and one institution may classify this procedure under head while another may include it under neck.

A clinical decision support software application module may be provided that supports relevant prior study matching and allows a radiologist to filter prior studies using anatomy as well as organ system. Such a module may comprise a context extraction module to automatically determine the most specific body part (or parts) of a particular study. Moreover, a reference anatomy taxonomy may be provided representing the various body parts along with their interrelationships. The taxonomy may also provide information regarding abbreviations, synonyms, and the like. Relevant ontology codes, e.g. from SNOMED or RadLex, could be included for each term. This taxonomy may be used by the context extraction module to map the body part, which may be a plain text metadata field, into a standardized term.

Moreover, an intelligent study matching module may be provided that determines a set of prior studies that are relevant to current study, i.e., as relevant to the current image's body part(s). A graphical user interface may be provided to allow a user to easily find prior studies using an anatomy and/or organ based filter.

The context extraction module may be invoked by the body part determining unit 6, for example, to determine the determined body part. Moreover, the study matching module and/or the context extraction module may be invoked by the second selecting unit 8, for example, to match the body part of the selected documents with the determined body part.

These modules can be implemented using several approaches, and one is described below.

The context extraction module can be configured to determine the context of an input imaging study. For a given study, the module can extract the anatomy-related information by processing several metadata fields of the study. In this example, the DICOM standard is used to explain the techniques. However, similar techniques may be applied on data stored in other data formats.

For example, the Study Description field corresponding to DICOM tag (0008, 1030), the Protocol Name field corresponding to DICOM tag (0018, 1030) and the Series Description field corresponding to DICOM tag (0008, 103e) all may contain anatomy related information.

If available, the Protocol Name and/or Series Description may be the most specific and contain the sequence level anatomy information. An imaging study can have multiple sequences e.g., a single abdomen study may contain multiple sequences also commonly referred to as image series such as axial, coronal, with contrast, without contrast, kidney, liver, and so on. Depending on the study, this information may be available in the Study Description as well.

For example, the following Table 1 shows metadata fields available to describe different kinds of studies that may be performed on patients.

TABLE 1
Study Description and Body Part fields of a number of different kinds
of studies

| Study Description | Body Part |
|---|---|
| CT ABDOMEN WITH CONTRAST/SPLEEN | ABDOMEN |
| CT ABDOMEN WITHOUT CONTRAST/PANCREAS | ABDOMEN |
| CT ABDOMEN WITH AND WITHOUT CONTRAST/ | ABDOMEN |
| PANCREAS | |
| CT ABDOMEN WITH CONTRAST/PANCREAS | ABDOMEN |
| CT ABDOMEN WITHOUT CONTRAST/LIVER | ABDOMEN |
| CT ABDOMEN WITH AND WITHOUT CONTRAST/ | ABDOMEN |
| LIVER | |
| CT ABDOMEN WITH CONTRAST/LIVER | ABDOMEN |
| CT ABDOMEN WITHOUT CONTRAST/KIDNEYS | ABDOMEN |

Typically, the DICOM Study Description field is populated with a description of the procedure, for example one of the descriptions in Table 1. Although, for all the procedure types shown in Table 1, the DICOM body part field is set to abdomen, from the descriptions it can be inferred that the more specific body parts are spleen, pancreas, liver and kidney. A set of rules, in combination with regular expressions where necessary, can be used to extract the desired body part information from the study description field.

For example, the context extraction module may use the Protocol Name and/or Series Description fields first to determine the most specific body part(s) associated with a study. If this is not available, the module may use the Study Description field to determine body part. As a last resort, the module may be configured to return the Body Part field. What is described here is one specific implementation to extract the body part from the DICOM header. Other approaches may include machine learning approaches, more computationally intensive natural language based approaches and data mining based approaches. In another embodiment, the radiology report, especially the impressions section, can be parsed using natural language processing (NLP) to identify the associated body parts.

The module may extract the body part information from the Study Description, Protocol Name and/or Series Description. As a result, a feature vector containing all body parts associated with the study may be created. This gives the consumer application of this module the flexibility to use the body part information at a desired level of generality (e.g., more general vs. more specific). This will be explained hereinafter.

A reference taxonomy may be used to perform the matching described in the previous step. This reference taxonomy may be structured so that it has the following properties. There may be a parent-child relationship between concepts to denote, for example, that a (parent) concept can have one or more components in form of (child) concepts. Alternatively, a child concept may represent a qualifier of its parent concept. Concepts can have multiple abbreviations and synonyms defined in the reference taxonomy. Child concepts inherit properties from their parent concepts. For instance, upper extremity may have an abbreviation UE, and two children concepts Left upper extremity and right upper extremity. In this case, the children concepts will also inherit the abbreviation UE, but a child concept will be matched only if the laterality (i.e., left or right) is also specified. A concept may be interpreted within the context of its ancestor. For instance, the term soft tissues may appear multiple times in the taxonomy, but interpretation depends on the context. For example, if the study description was MRI P FACE SOFT TISSUE W, the matched term would be face soft tissues with SnomedCode 95937008 whereas study description CT SOFT TISSUE HEAD would match to head soft tissues with SnomedCode 127960009.

The taxonomy may provide a representation of intention of procedure. Moreover, it does not necessarily contain a complete list of all body parts. For instance, an XR UROGRAPHY RETROGRADE (also called cystoscopic urography) is an X-ray examination of urinary tract after contrast injection and as such, urography is used as synonymous to the urinary tract. Similarly, a mammogram study usually does not explicitly mention breast (e.g., MAM BILAT DIGITAL W/CAD), and therefore body parts associated with such common procedures may be captured in the knowledgebase.

A concept may need to be represented by more than one SNOMED-CT or RadLex term. This is explained by the fact that there may not necessarily be a one-to-one mapping between SNOMED-CT and RadLex ontologies. For instance, the concept left upper extremity corresponds to SNOMED code 80768000 whereas in RadLex this is not a single concept, and needs to be represented as upper extremity (RadLex code RID1850) and left position (RadLex code RID5824).

The study matching module may be configured to determine a minimum set of prior studies that are relevant to current study. Each time a new study is opened, this module may call the context extraction module to determine a feature vector comprising body part(s) for current study. Based on this, it may determine which prior studies are relevant by using the reference taxonomy for guidance. Alternatively, with reference to FIG. 1, when a study is opened, the specialty determining unit 21 determines the specialty of the physician of the study, and the body part determining unit 6 invokes the context extraction module to determine the feature vector comprising body part(s) for the studies found by the first selecting unit 4. The second selecting unit 8 may then invoke the context extraction module to determine the feature vector comprising body part(s) for other studies in the health record. The second selecting unit 8 may match the body part(s) of those other studies against the body part(s) of the studies found by the first selecting unit 4. When a match is detected, the second selecting unit 8 may include a matching other study in the second set of documents 9. A match may be configured to be detected when the feature vectors are identical. Alternatively, the second selecting unit 8 may be configured to apply a set of predetermined rules to decide whether two vectors match or not.

A study may be, in some embodiments, deemed ‘relevant’ if there is at least one series in the study that matches the applicable body part(s). Also, a child concept may match with a parent concept. For instance, if current study body part is Face and a prior study has Nose as its body part, this will still be a relevant prior since Nose is a child of concept Face according to the taxonomy. Relevant prior studies may then be displayed to the user, for instance, by showing these in a ‘Relevant Exams’ timeline.

Another approach is to define a matrix to compare the feature vector of the current study with those of prior studies. For instance, the matrix can contain the feature vectors from the current study (or from the studies of the first set of documents 5) as well as relevant prior studies. Each column could represent a feature with each row in the matrix showing the extracted feature information for Study. Out of all potentially relevant prior studies, the user can then select the one they deem most relevant.

A screen shot of a graphical user interface is shown in FIG. 3. Such a graphical user interface may be used to allow a user to easily find prior studies using an organ and/or anatomy based filter. As shown in FIG. 3, the interface can be used to first filter by organ system. For example, the user interface comprises a first panel 301 with a number of buttons, each button representing an organ system. Button 303 represents the urinary system. An organ system typically contains multiple body parts (e.g., the urinary system may contain kidney, liver and urinary bladder among others). A secondary level of filtering can also be provided by showing a representation of at least part of the taxonomy 302 corresponding to a selected body part using the body part filter user interface 302. Alternatively, once the urinary system is selected using button 303, a user can additionally select ‘Vascular Structures’. This will select studies showing vascular structures within the urinary system. On the other hand, the body part filter 302 can be used on its own if Vascular Structures is selected without specifying an organ system, this will show vascular structure related studies for entire body.

The selecting of documents from a health record of a patient may also involve the following. A study analysis unit may be provided for analyzing a document of the health record to extract date information from the document which is indicative of date of a study related to the document. Moreover, a third selecting unit may be provided for selecting a further document from the health record based on a date of the further document matching the date of the study. The study analysis unit may be arranged for extracting the date information from the document in various ways, e.g., by detecting the date of a prior study in a comparison section of the document, and/or detecting a follow-up recommendation indicative of the date of a follow-up study.

The following illustrates the extracting of such date information on the basis of an example of a radiology report from a health record of a patient:

CT P HEAD WO, 31-Dec-2011 4:40 PM
CLINICAL INFORMATION: 15 year old male with left upper extremity
weakness.
COMPARISON: CT head 30-Dec-2011
TECHNIQUE: Ppp, Sss of the head was performed without contrast.
Multiplanar reformatted images were rendered.
FINDINGS:
The previously seen hypodensity, consistent with evolving infarction, in
the right basal ganglia, insula, and small portions of the adjacent right
temporal lobe has been stable without hemorrhagic conversion.
There is no new area of hypodensity to suggest additional sites of
territorial ischemia. There is no abnormal fluid collection. The
ventricles and the sulci are unremarkable except for mild effacement of the
right lateral ventricle. There is no midline shift or basal cistern
effacement.
Orbits are unremarkable. Paranasal sinuses are clear apart from some fluid
in the ethmoid air cells and mucosal thickening in the sphenoid sinuses.
Mastoid air cells remain clear. There is a right nasal route tube.
IMPRESSION: Stable infarcts in the right basal ganglia, insula and
adjacent right temporal lobe without hemorrhagic conversion. No
new area of hypodensity to suggest additional sites of territorial
ischemia. CT follow-up is recommended in 3 months.
Report Electronically Signed: 01-Jan-2012 9:01 AM John Doe, M.D.

It can be seen from the above radiology report that the comparison section refers to a prior CT study, namely “CT head 30 Dec. 2011”. From this section, the study analysis unit may infer the date of the prior study as “30 Dec. 2011”. Also, the radiology report refers to a CT follow-up study in 3 months. Together with the date of the present radiology report, namely “31 Dec. 2011”, the study analysis unit may infer the date of the follow-up study to be approximately three months, namely around “31 Mar. 2012”.

The study analysis unit and the third selecting unit may be arranged for iteratively selecting and analyzing further documents from the health record to obtain a third set of documents corresponding to a sequence of studies. The following table illustrates this concept in that it shows documents from the health record of a patient which each relate to a particular study, e.g., in that they are laboratory results, reports, etc, associated with the study. The date of each study is mentioned in the first column. The second column indicates a date mentioned in the “Comparison” section of a respective report. The third column indicates a follow-up recommendation mentioned in the “Impressions” section of the respective report. The fourth column indicates the body part and modality of the study.

TABLE 2
Overview of documents from the health record of a patient

| | | Recommendation | | | |
|---|---|---|---|---|---|
| | Content of | of follow-ups | BodyPart | | |
| | the | in the | and | | |
| | Comparison | Impression | Modality | | |
| Date of | Section of | section of the | of the | Class | |
| the study | the report | report | study | 1 | Class 2 |
| 2012-03- | | | CT, Head | X | |
| 10 | | | | | |
| 2011-12- | 2011-12-30 | CT follow-up | CT, Head | X | |
| 31 | | is recommended | | | |
| | | in 3 months. | | | |
| 2011-12- | 2011-06-06 | | MRI Head | X | |
| 30 | | | | | |
| 2011-07- | n.a. | | CT, | | X |
| 01 | | | Abdomen | | |
| 2011-06- | 2011-05-05 | | CTA, | X | |
| 06 | | | Brain | | |
| 2011-05- | n.a. | | MRI, | X | |
| 05 | | | Neuro | | |
| 2011-02- | n.a. | | XRay, | | X |
| 04 | | | Chest | | |

A set of documents may be selected from the above documents in the following manner. The report on the study dated 2011 Dec. 31 uses a prior study dated 2011 Dec. 30 for comparison and includes the recommendation to follow-up the study in approximately 3 month, thereby referring to the study of 2012 Mar. 10. In turn, the prior study dated 2011 Dec. 30 uses a comparison a study dated 2011 Jun. 6, and in turn, this study uses as comparison a study dated 2011 May 5. Accordingly, it may be determined that the above documents are related and may be classified as belonging to a common class, e.g., ‘Class 1’. Moreover, it may be determined that the studies dated on 2011 Jul. 1 and 2011 Feb. 4 are not related to the studies of ‘Class 1’ but rather belong to a separate class, e.g., ‘Class 2’. This may be determined on the basis of an absence of references to either document, and/or the body part determining unit determining that said documents do not involve the brain.

Accordingly, it may be determined that the documents belonging to ‘Class 1’ are mutually related, whereas the documents belonging to ‘Class 2’ may be mutually related but not related to the documents of ‘Class 1’. This relation may be visualized to a user, e.g., by indicating the documents of the health record on a time line and highlighting or otherwise distinguishing related studies which are relevant in the present context.

The above document selection may be implemented in various ways. For example, the study analysis unit may employ a Natural Language Processing (NLP) engine to analyze separate sections, paragraphs and sentences of a document. In particular, the NLP engine may detect and extract the dates of prior studies from the “Comparison” section of a report. Moreover, the NLP engine may extract the content of the “Impressions” section and detect and extract any follow-up recommendation indicated with dates/duration. The study analysis unit may further comprise a temporal reasoning module which assigns the studies into different classes so that each class forms a sequence of studies, in that each study uses an earlier study from the same class as comparison and/or a later study as follow-up. It is noted that such NLP engines are known per se from the field of Natural Language Processing and within reach of the skilled person. Moreover, machine learning algorithms may be used to determine whether a sentence contains a follow-up recommendation. Having detected a set of documents representing the sequence of studies, the documents and/or image data associated with the documents may be pre-fetched into a workstation, e.g., from a Picture Archiving and Communication System (PACS). Moreover, on the workstation, studies belonging to the same class may be grouped together or otherwise jointly distinguished from other documents from the health record. Alternatively, when the radiologist selects a study using a graphical user interface of the workstation, other studies in the same class may be visualized.

It is noted that the documents may be imaging reports. However, the above may equally applied to non-imaging reports, e.g. pathology and laboratory reports.

It will be appreciated that the different selecting units may co-operate in that logical conjunctions (“AND”) or disjunctions (“OR”) of selections may be performed. The study analysis unit and third selecting unit may also be separately implemented as a system, i.e., without the specialty unit, first selecting unit, body part determining unit and/or second selecting unit. Yet another possibility is that selections may be performed sequentially, i.e., from the output of another selecting unit. For example, the first selecting unit may be arranged for selecting the first set of documents from the third set of documents, the second selecting unit may be arranged for selecting the second set of documents from the third set of documents, and/or the third selecting unit may be arranged for selecting the third set of documents from the first set of documents and/or the second set of documents.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a flash drive or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for selecting a set of documents from a health record of a patient wherein the health record comprises a plurality of documents, the system comprising:
a specialty unit for determining a specialty to be used for selecting the set of documents, to obtain a determined specialty;
a first selecting unit for selecting a first set of documents from the health record, wherein a specialty of a physician associated with the documents of the first set of documents matches the determined specialty;
a body part determining unit for determining a body part associated with at least one document of the first set of documents, to obtain a determined body part;
and a second selecting unit for selecting a second set of documents from the health record, wherein a body part associated with the documents of the second set of documents matches the determined body part.

2. The system of claim 1, further comprising a display setting determining unit for determining a document display setting associated with at least one document of the first set of documents, wherein the document display setting relates to information regarding a display setting used in a previous display of the document, to obtain a determined document display setting; and wherein the second selecting unit is further arranged for matching a display setting associated with a document from the health record with the determined document display setting.

3. The system of claim 1, wherein the specialty unit is further arranged for selecting a query document from the health record of the patient and for determining a specialty of a physician associated with the selected document as the determined specialty.

4. The system of claim 3, wherein if the specialty unit fails in determining the determined specialty, the second selecting unit is arranged for determining the second set of documents by extracting from the health record of the patient a set of documents wherein a body part associated with the documents of the second set of documents matches the body part associated with the query document.

5. The system of claim 3, wherein the specialty unit is arranged for extracting an identifier of the physician from metadata of the query document and determining the determined specialty of the physician associated with the document based on a table of identifiers of physicians and associated specialties.

6. The system of claim 1, further comprising:
a study analysis unit for analyzing a document of the health record to extract date information from the document, the date information being indicative of date of a study related to the document; and
a third selecting unit for selecting a further document from the health record based on a date of the further document matching the date of the study.

7. The system of claim 6, wherein the study analysis unit is arranged for extracting the date information from the document by:
detecting the date of a prior study in a comparison section of the document, and/or
detecting a follow-up recommendation indicative of the date of a follow-up study.

8. The system of claim 6, wherein the study analysis unit and the third selecting unit are arranged for iteratively selecting and analyzing further documents from the health record to obtain a third set of documents corresponding to a sequence of studies.

9. The system of claim 8,
wherein the first selecting unit is arranged for selecting the first set of documents from the third set of documents, and/or the second selecting unit is arranged for selecting the second set of documents from the third set of documents;
or wherein the third selecting unit is arranged for selecting the third set of documents from the first set of documents and/or the second set of documents.

10. The system of claim 1, wherein the body part determining unit is arranged for determining the body part based on metadata of said at least one document of the first set of documents, for example, using at least one of a Study Description field, a Protocol Name field, and a Series Description field of the metadata of said at least one document of the first set of documents.

11. The system of claim 1, further comprising a time range generating unit to generate a time range based on the determined specialty and wherein the first or the second selecting unit is arranged for selecting the first or the second set of documents, respectively, from the health record of the patient such that a creation time of the documents of the first or second set of documents, respectively, is inside the time range.

12. The system of claim 1, further comprising a display unit for displaying the first set of documents and the second set of documents and displaying, for each document, an indication of the set to which each document belongs.

13. A workstation comprising the system of claim 1.

14. A method of selecting a set of documents from a health record of a patient, wherein the health record comprises a plurality of documents, the method comprising the steps of:
determining a specialty to be used for selecting the set of documents, to obtain a determined specialty;
selecting a first set of documents from the health record, wherein a specialty of a physician associated with the documents of the first set of documents matches the determined specialty;
determining a body part associated with at least one document of the first set of documents, to obtain a determined body part;
and selecting a second set of documents from the health record, wherein a body part associated with the documents of the second set of documents matches the determined body part.

15. A computer program product comprising instructions for causing a computer system to perform the method according to claim 14.
